(19) United States
(12) Patent Application Publication
(10) Pub. No.: US 2025/0141229 A1
(43) Pub. Date: May 1, 2025

(54) METHOD AND SYSTEM FOR REGULATING POWER CONSUMPTION WITHIN AN ELECTRIC POWER GRID

(71) Applicant: JBB Advanced Technologies, LLC, DALLAS, TX (US)

(72) Inventors: John Taylor Billingsley, JR., Dallas, TX (US); Ronald Lyle Chichester, Waller, TX (US); Jason Alexander Novack, Frisco, TX (US)

(73) Assignee: JBB Advanced Technologies, LLC, DALLAS, TX (US)

(21) Appl. No.: 18/496,867

(22) Filed: Oct. 28, 2023

(51) Int. Cl. H02J 3/12; G06Q 20/38; H02J 3/38; H02J 13/00

(52) U.S. Cl. CPC H02J 3/12; G06Q 20/389; H02J 3/38; H02J 13/00022; H02J 13/00028; H02J 2300/24; H02J 2300/28

(57) ABSTRACT

A method and system for regulating power consumption on an electric power grid is disclosed. Blockchain miners are used as a load bank that can be modulated quickly to accommodate spikes or dips in power generated from wind and solar power producers. The cryptocurrency generated by the blockchain miners allows electric grid owners to recoup the costs of higher overall power production, and accommodates fluctuations that are characteristic of wind and solar power generation devices because the fluctuations from wind and solar devices can be matched by modulating the computational speed of the blockchain miners in equal amounts, thus matching the overall demand and production of the power on the electric grid.

### PRIORITY CLAIM

The present patent application claims priority under 35 U.S.C. § 119 (e) (1) to provisional application No. 63/424,390 filed on Nov. 10, 2022, the contents of which are incorporated herein by reference.

### TECHNICAL FIELD

The present invention relates to energy production and consumption in general, and in particular to a method and system for regulating power consumption within an electric power grid.

### BACKGROUND

According to the United States Energy Information Administration (EIA), “[r]enewable energy is energy from sources that are naturally replenishing but flow-limited; renewable resources are virtually inexhaustible in duration but limited in the amount of energy that is available per unit of time.” Renewable energy resources include: wood and wood waste, municipal solid (biomass) waste, landfill gas and biogas; biofuels; hydropower, geothermal, wind; and solar.

Further, according to the EIA, “[u]ntil the mid-1800s, wood was the source of nearly all of the nation's energy needs for heating, cooking, and lighting. From the late 1800s until today, fossil fuels-coal, petroleum, and natural gas—have been the major sources of energy. Hydropower and wood were the most used renewable energy resources until the 1990s. Since then, the amounts of U.S. energy consumption from biofuels, geothermal energy, solar energy, and wind energy have increased. Total U.S. renewable energy production and consumption reached record highs in 2021.”

However, “[i]n 2021, renewable energy provided about 12.16 quadrillion British thermal units (BTU)-quadrillion is the number 1 followed by 15 zeros-equal to 12% of total U.S. energy consumption. The electric power sector accounted for about 59% of total U.S. renewable energy consumption in 2021, and about 20% of total U.S. electricity generation was from renewable energy sources.”

The outlook for renewables is bright. Again, according to the EIA, between now and 2050, “[r]enewables will be the primary source for new electricity generation, but natural gas, coal, and increasingly batteries will be used to help meet load and support grid reliability.”

Unfortunately, power generated by wind and solar is dependent upon a host of variables that are not under human control, such as the weather. When the wind does not blow, or the sky is cloudy or dark, power will not be generated by wind turbines or solar panels. These variables have made wind and solar power producers difficult for grid operations to incorporate into existing grid infrastructure because the fluctuations in renewable power generation have an effect on the voltage maintained by the grid, and thus require grid operators to modulate the fluctuations by throttling other grid power producers.

### SUMMARY

It would be desirable to provide a system and method for modulating voltage within an electric power grid by using renewable energy generators. A fossil-fuel thermal power plant utilizes one or more turbines to extract work from a working fluid such as steam. Because turbines are inherently more efficient at specific working conditions, the overall efficiency of the power plant varies in proportion to the efficiency of the thermal power plant's turbines. Consequently, thermal power plants that have design points (or design curves) can be operated more efficiently at a higher, steady, load and any fluctuations in the voltage of the power grid can be modulated by using a group of peaker load banks that incorporate blockchain miners serving as the load. The blockchain miners can be utilized as a mechanism for recouping, if necessary, the monetary loss for running the thermal power plant at a higher power output, even though the higher power output corresponds to higher efficiency on a per-unit-of-energy basis for the thermal power plant.

In accordance with one embodiment of the invention, a peaker load bank is connected to an electric power grid having a thermal power plant and multiple renewable power sources for providing power to the electric power grid. The peaker load bank includes one or more blockchain miners operating to mine a cryptocurrency. A central control unit is utilized to control the blockchain miners within the peaker load bank. The central control unit receives power consumption messages from the thermal power plant on predetermined intervals. After the receipt of a power consumption message from the thermal power plant, a determination is made whether or not the power consumption message indicates that generated power exceeds power demand within the electric power grid. In response to a determination that the power consumption message indicates that generated power exceeds power demand within the electric power grid, a first signal is sent from the central control unit to the blockchain miners to increase the speed of mining in order to consume the excess generated power. In response to a determination that the power consumption message indicates that power demand exceeds generated power within the electric power grid, a second signal is sent from the central control unit to the blockchain miners to decrease the speed of mining in order to reduce power demand.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of an electric power grid, according to the prior art;

FIG. 2 is a block diagram of an electric power grid, according to one embodiment of the present invention;

FIG. 3 is a detailed diagram of a peaker load bank within the electric power grid in FIG. 2, in accordance with one embodiment of the present invention;

FIG. 4 is a high-level flow diagram of a method for regulating power consumption on an electric power grid, according to one embodiment of the present invention; and

FIG. 5 graphically illustrates power consumption versus hash rate for a blockchain miner.

### DETAILED DESCRIPTION OF A PREFERRED EMBODIMENT

Referring now to the drawings and in particular to FIG. 1, there is illustrated a block diagram of an electric power grid, according to the prior art. As shown, a power grid 10 produces power that is generated by a thermal power plant 11. Thermal power plant 11 utilizes the Rankine thermodynamic cycle, wherein water is heated and the resulting high-pressure steam is piped into one or more turbines that extracts work from the steam to turn electric generators. Thermal power plant 11 is operably connected to transformers 12 that step up the voltage for transmission on high-tension power lines that deliver power to one or more substations 13. In turn, substations 13 step down the voltage of the power received from the power lines, and the power transmission continues via distribution lines to various power consumers, such as industrial sites 14, commercial sites 15, and/or residential sites 16.

The bulk of electricity in the power grids of the United States is generated by thermal power plants, such as thermal power plants 11, which include fossil-fueled plants and nuclear-fueled plants. The fundamental challenge with operating power grids is matching energy production with energy consumption. That challenge is more acute for thermal power plants because their equipment is not as amendable to energy fluctuation as other types of power plants.

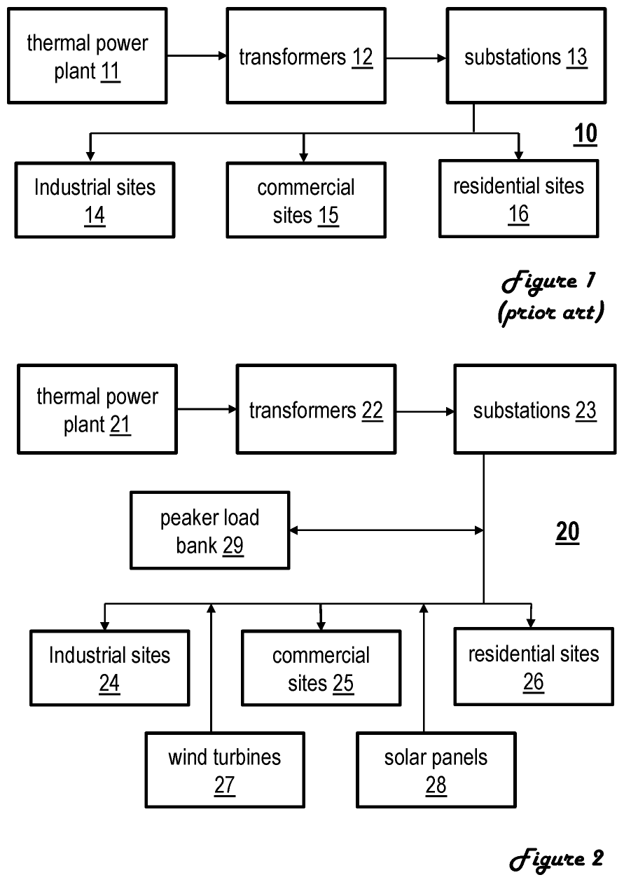

With reference now to FIG. 2, there is illustrated a power grid 20, according to one embodiment of the present invention. As shown, power grid 20 includes a thermal power plant 21, a transformer 22 and one or more substations 23. Transformers 22 step up the voltage from thermal power plant 21 for transmission on high-tension power lines that delivers power to substations 23. In addition, power grid 20 includes renewable energy devices, such as solar panels 27 and wind turbines 28, that can provide energy to power grid 20. Power grid 20 also includes a peaker load bank 29. Peaker load bank 29 along with solar panels 27 and wind turbines 28 are connected to the distribution lines between (preferably) substations 23 and power consumers such as industrial sites 24, commercial sites 25, and/or residential sites 26. The positioning of peaker load bank 29 on the distribution lines places the modulation functionality of peaker load bank 29 in the best proximity to the sources of power fluctuations (i.e., the power consumption side and/or the side with intermittent renewable energy sources) within power grid 20.

In the past, additional intermittent energy from renewables, such as solar panels 27 and wind turbines 28 would cause unwanted (or unacceptable) fluctuations in power grid 20. The present invention, however, solves the voltage matching problem in a rather counter-intuitive manner. First, instead of using thermal power plant 21 to modulate its output, the output of thermal power plant 21 is set higher than the projected demand and held steady. Ideally, thermal power plant 21's higher production level would correspond to higher efficiency levels for the turbines and other elements that most profoundly affect the overall efficiency of thermal power plant 21. In the prior art, such steady power production was not possible because of the need to modulate the voltage (i.e., to match power consumption and power production) on an electric power grid. With the present invention, the modulation of the voltage on the electric power grid would be controlled and managed via peaker load bank 29 in a much faster and more precise manner.

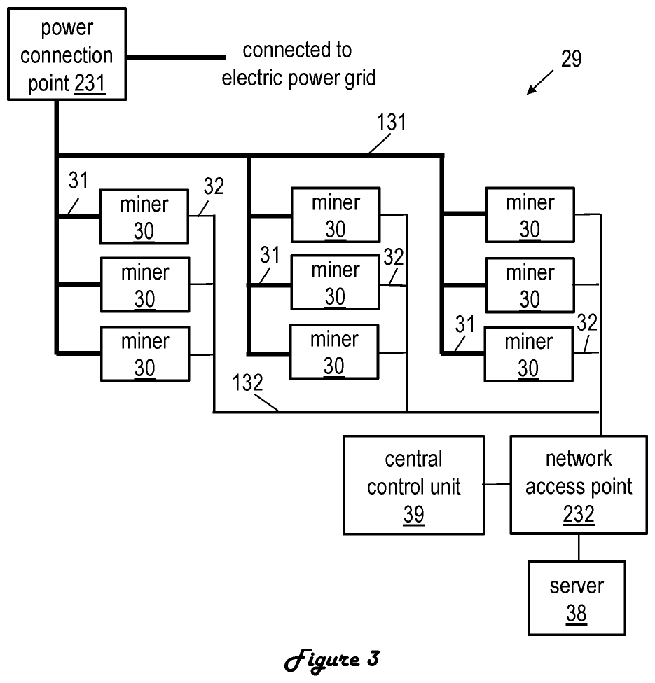

Referring now to FIG. 3, there is illustrated a detailed diagram of peaker load bank 29, according to one embodiment of the present invention. As shown, peaker load bank 29 includes a set of blockchain miners 30, such as the Bitmain S19, housed in a building, that is connected to the distribution lines located between substations 23 and power consumers such as industrial sites 24, commercial sites 25, and/or residential sites 26 (see FIG. 2). Blockchain miners 30 can be identical to each other with the same capabilities or different from each other with different capabilities.

Since blockchain miners 30 need power to operate, each of blockchain miners 30 includes a power connector 31. Blockchain miners 30 also require access to a local-area network or a wide-area network such as the Internet. Thus, each of blockchain miners 30 includes a network connector 32. Software can be used to control blockchain miners 30 individually, in sets, or uniformly, via the network.

A power line is connected to a power connection 231 of peaker load bank 29. Power is then distributed to blockchain miners 30 via power buses 131. Similarly, network access is provided by, for example, Ethernet cables 132, which are then connected to a modem or router at network access point 232. It should be noted, however, that blockchain miners 30 could optionally be equipped with wireless network interface cards that could communicate with network access point 232 without the need for ethernet cables 132.

Blockchain miners 30 are generally configured to operate at a static hash rate (e.g., 110 terahashs/second) for a static power rating (e.g., 3,250 Watts). However, the operating system of blockchain miners 30 can be modified to allow the hash rate to be changed dynamically and remotely.

Blockchain miners 30 can be housed within a facility that is fitted with a server 38. Server 38 includes communication software that monitors a pre-designated port (e.g., port 4080) for messages sent from a thermal power plant via the Internet or other wide-area networks. The communication software receives messages from the thermal power plant with an intention of maintaining the correct performance level of an electric power grid that is serviced by the thermal power plant. The communication software may also provide the thermal power plant an appraisal of the health and capabilities of blockchain miners 30 by requesting central control unit 39 to poll blockchain miners 30 regarding the health of each individual blockchain miner, the hash range that each individual blockchain miner can operate, whether or not each individual blockchain miner can be placed on a “standby mode” (to minimize power consumption without being powered down).

In conjunction with the server, a central control unit 39 is utilized to control blockchain miners 30 within peaker load bank 29. On predetermined time intervals, central control unit 39 receives messages from a thermal power plant via the server. The message can be sent by the thermal power plant at, for example, every minute. The message itself can be transmitted by, for example, the internet in the form of a packet, application programming interface (API) call, or the like. Alternatively, in lieu of the internet, a suitable message may be sent via a telecommunications network, or the like.

When the electric power grid includes the thermal power plant and multiple renewable power sources as electric power generators, at times the generated power on the grid may exceed the power demand within the electric power grid. This may cause problems to some of the equipment within the electric power grid. It would be impractical, if not impossible, for the thermal power plant and/or the renewable power sources to react quickly to the constant changes of power demand within the electric power grid. Thus, for the purpose of regulating power consumption within an electric power grid, the thermal power plant sends a “power consumption message” to central control unit 39 within peaker load bank 29. The power consumption message indicates whether or not the power generated by the thermal power plant exceeds or below the power demand within the electric power grid. Specifically, each power consumption message includes, for example, the following fields:
i. a timestamp of when the message was sent;
ii. generated power exceeds power demand by x amount, or power demand exceeds generated power by y amount.
   In other words, the power consumption message indicates whether or not the power the electric power grid is receiving excess power.

Central control unit 39 keeps track of various information of blockchain miners 30 regarding the health of each individual blockchain miner, the hash range that each individual blockchain miner can operate, etc. After receiving a power consumption message from the thermal power plant, central control unit 39 evaluates what it takes to reduce the stated x amount of excess generated power or reduce the stated y amount of excess power demand by turning on or off an appropriate number of blockchain miners 30 quickly. This can be accomplished by sending a first or second signal to blockchain miners 30, depending on the information on the power consumption message. For example, a first signal directs an appropriate number of blockchain miners 30 to increase the speed of mining, and a second signal directs an appropriate blockchain miners 30 to decrease the speed of mining or to enter standby mode or to shut down.

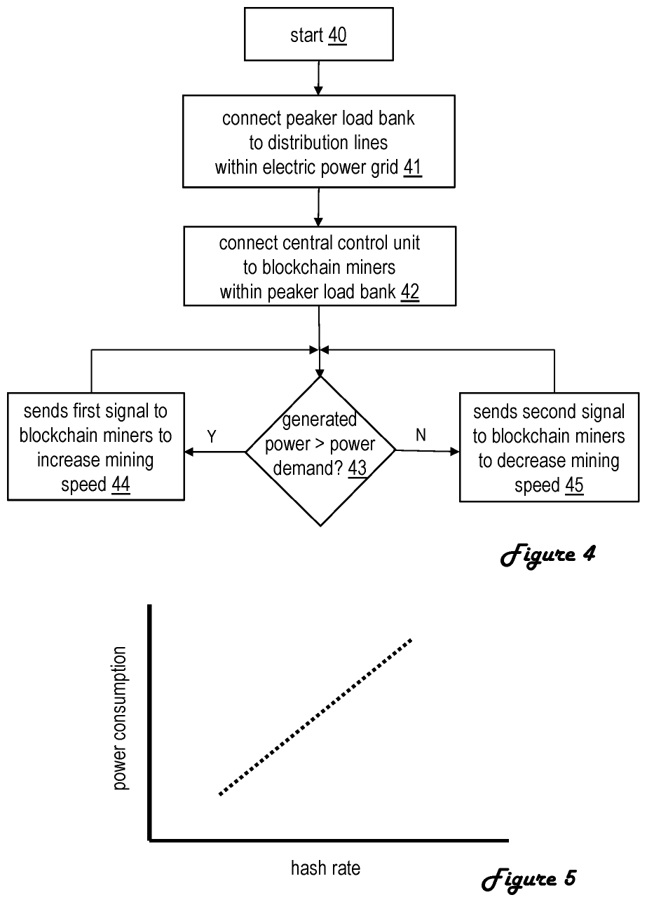

With reference now to FIG. 4, there is illustrated a high-level flow diagram of a method for regulating power consumption on an electric power grid, according to one embodiment of the present invention. The electric power grid includes a primary power source, such as thermal power plant 21 in FIG. 2, and one or more renewable power sources, such as wind turbines 27 and solar panels 28 in FIG. 2. The primary power source and the one or more renewable power sources provide electric power to the electric power grid. Starting at block 40, a peaker load bank, such as peaker load bank 29 in FIG. 2, is connected to the distribution lines between substations and power consumers such as industrial sites, commercial sites, and/or residential sites, of the electric power grid, as shown in block 41. The peaker load bank includes one or more blockchain miners, such as blockchain miners 30 in FIG. 3, that receive power from the electric power grid and operate to mine a cryptocurrency. The electric power received from the electric power grid by the blockchain miners can be modulated by changing the speed of cryptocurrency mining. The speed of cryptocurrency mining can be changed by changing, for example, the hash rate of each of blockchain miners 30.

Next, a central control unit, such as central control unit 39 in FIG. 3, is connected to the one or more blockchain miners within the peaker load bank, as depicted in block 42. The central control unit is utilized to control the blockchain miners within the peaker load bank. The central control unit receives a power consumption message from the thermal power plant, and in turn sends a first or second signal that sets the speed of mining for the blockchain miners. After receiving the power consumption message, a determination is made by the central control unit whether or not the power consumption message indicates that generated power exceeds power demand within the electric power grid, as shown in block 43. In response to a determination that generated power exceeds power demand within the electric power grid, the central control unit sends a first signal to the blockchain miners to increase the speed of mining in order to absorb the excess power, as depicted in block 44, and the process returns back to block 43. On the other hand, in response to a determination that power demand exceeds generated power within the electric power grid (i.e., excess power demand), the central control unit sends a second signal to the blockchain miners to decrease the speed of mining in order to reduce the excess power demand, as shown in block 45, and the process returns back to block 43.

Referring now to FIG. 5, there is illustrated a graph of how the power consumption of blockchain miners 30 increases with higher hash rate. Since the power consumption of blockchain miners 30 is directly proportional to the hash rate, the overall power consumption of blockchain miners 30 can be modulated by modulating the hash rate. The operating system of blockchain miners 30 can be modified to accept commands dynamically to increase or decrease the hash rate of blockchain miners 30, which has a corresponding effect of increasing or decreasing, respectively, the power consumption of blockchain miners 30. Such modulation of the power consumption of blockchain miners 30 can then be used to counteract the lowering or the raising of demand by power consumers, such as industrial sites 24, commercial sites 25, and/or residences 26, and renewable energy sources such as solar panels 27 and wind turbines 28.

The software used to modulate blockchain miners 30 can be operated by, for example, central control unit 39. It is understood that government regulations may be required to induce citizens in otherwise non-regulated industries, businesses or residences to surrender certain rights to their respective blockchain miners 30 in order to obtain the necessary license to connect blockchain miner 30 to power grid 20.

As has been described, the present invention provides a peaker load bank that can modulate power fluctuations on an electric grid and, at the same time, offset its modulation costs by mining one or more cryptocurrencies.

While the invention has been particularly shown and described with reference to a preferred embodiment, it will be understood by those skilled in the art that various changes in form and detail may be made therein without departing from the spirit and scope of the invention.

What is claimed is:

1. A method of regulating power consumption on an electric power grid, said method comprising:
connecting a peaker load bank to an electric power grid having a primary power source and one or more renewable power sources for providing power to said electric power grid, wherein said peaker load bank includes one or more blockchain miners operating to mine a cryptocurrency;
connecting a central control unit to said one or more blockchain miners within said peaker load bank, wherein said central control unit receives power consumption messages from said primary power source on predetermined time intervals;
after the receipt of a power consumption messages, determining whether or not said power consumption message indicates generated power exceeds power demand within said electric power grid; and
in response to a determination that said power consumption message indicates generated power exceeds power demand within said electric power grid, sending a first signal from said central control unit to said one or more blockchain miners to increase the speed of mining in order to consume said excess generated power.

2. The method of claim 1, wherein said method further includes in response to a determination that said power consumption message indicates power demand exceeds generated power within said electric power grid, sending a second signal from said central control unit to said one or more blockchain miners to decrease the speed of mining in order to reduce power demand.

3. The method of claim 1, wherein said primary power source is a thermal power plant.

4. The method of claim 1, wherein said renewable power source is one or more wind turbines.

5. The method of claim 1, wherein said renewable power source is one or more solar panels.

6. The method of claim 1, wherein said mining speed increase results in a higher power consumption by said one or more blockchain miners from said electric power grid.

7. The method of claim 1, wherein said mining speed decrease results in a lower power consumption by said one or more blockchain miners from said electric power grid.

8. The method of claim 1, wherein said power consumption message includes a timestamp and power demand information.

9. The method of claim 1, wherein said mining speed of said blockchain miners is modulated by changing their hash rate.

10. The method of claim 1, wherein said power consumption message is sent via the Internet or wirelessly.

11. An electric power grid, comprising:
a primary power source and one or more renewable power sources for providing electric power to said electric power grid;
a peaker load bank having one or more blockchain miners operate to mine a cryptocurrency; and
a central control unit, connected to said one or more blockchain miners, for
determining, after the receipt of a power consumption message from said primary power source, whether or not said power consumption message indicates said electric power grid is receiving excess power; and
sending a first signal to said one or more blockchain miners to increase the speed of mining in order to absorb said excess power, in response to a determination that said power consumption message indicates said electric power grid is receiving excess power.

12. The electric power grid of claim 11, wherein said central control unit sends a second signal to said one or more blockchain miners to decrease the speed of mining in order to reduce excess demand, in response to a determination that said power consumption message indicates said electric power grid is not receiving excess power.

13. The electric power grid of claim 11, wherein said primary power source is a thermal power plant.

14. The electric power grid of claim 11, wherein said renewable power source is one or more wind turbines.

15. The electric power grid of claim 11, wherein said renewable power source is one or more solar panels.

16. The electric power grid of claim 11, wherein said power consumption message includes a timestamp and power demand information.

17. The electric power grid of claim 11, wherein said mining speed of said blockchain miners is modulated by changing their hash rate.

18. The electric power grid of claim 11, wherein said power consumption message is sent via the Internet.

19. The electric power grid of claim 11, wherein said power consumption message is sent wirelessly.
